(19) United States
(12) Patent Application Publication
(10) Pub. No.: US 2017/0019165 A1
(43) Pub. Date: Jan. 19, 2017

(54) LOOP DETECTION/RESOLUTION AND LOAD BALANCING ON DUAL BAND DUAL CONCURRENT REPEATER

(71) Applicant: QUALCOMM Incorporated, San Diego, CA (US)

(72) Inventors: Rathees Kumar Ramasamy Chinannan, Chennai (IN); Sasidhar Subramaniam, Chennai (IN); Sujatha Varadarajan, Chennai (IN)

(21) Appl. No.: 15/192,375

(22) Filed: Jun. 24, 2016

(30) Foreign Application Priority Data
Jul. 17, 2015 (IN) 3680/CHE/2015

(51) Int. Cl. H04B 7/14; H04L 29/06; H04W 72/00; H04W 72/04

(52) U.S. Cl. CPC H04B 7/14; H04W 72/0453; H04L 69/22; H04W 72/005; H04W 88/08

(57) ABSTRACT

A dual band dual concurrent (DBDC) repeater access point (AP) using two radios may detect a packet loop that has formed between a root AP and alter packet processing to resolve the loop. The DBDC repeater AP may include virtual access points (VAPs) that share a common connection table that identifies relationships between each client, VAP, and radio. The DBDC repeater AP may detect a packet loop by evaluating a packet received from the root AP and determining that they originated at the DBDC repeater AP or a client served by the DBDC repeater AP. The DBDC repeater may selectively process a packet based on a relationship between the packet source and one of the two radios. The relationship between the packet source and the radios may be determined by accessing the common connection table.

### CROSS REFERENCES

The present Application for Patent claims priority to Indian Provisional Patent Application No. 3680/CHE/2015 by Chinannan et al., entitled “Loop Detection/Resolution and Load Balancing on Dual Band Dual Concurrent Repeated,” filed Jul. 17, 2015, assigned to the assignee hereof.

### BACKGROUND

The following relates generally to wireless communication, and more specifically to loop detection, loop resolution, and load balancing on a dual band dual concurrent repeater (DBDC).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN) may include an access point (AP) that communicates with one or more stations (STAs) or mobile devices in its coverage area. In some cases, the AP may indirectly extend its coverage range by using a repeater AP that acts as a relay point between a root AP and clients that are outside of the coverage area of the root AP. In some cases, the repeater AP is a dual band dual concurrent (DBDC) repeater AP that communicates over two different radios simultaneously. When a DBDC repeater AP establishes two connections to a single root AP, a packet loop may be formed in which a packet is redundantly and indefinitely exchanged between the two APs. If such a loop is not detected and resolved, processing power and resources may be wasted.

### SUMMARY

A dual band dual concurrent (DBDC) repeater access point (AP) using two radios may detect a packet loop that has formed with a root AP and alter packet processing to resolve the loop. Each radio of the DBDC repeater AP may have a corresponding virtual access point (VAP) that shares a common connection table with another VAP. The common connection table may include identification and relationship information for clients, radios, and VAPs. The DBDC repeater AP may detect a packet loop by evaluating a packet received from the root AP and determining that the packet originated at the DBDC repeater AP (e.g., by accessing the connection table). The determination may be made by matching a source address of the packet to a client address that is supported by the DBDC repeater AP. After detection of the loop, the DBDC repeater AP may selectively process packets based on a radio configuration and/or a relationship between the packet source and one of the two radios. In one example, a VAP discards a packet if the VAP is not associated with a default radio set by a radio configuration. In some cases, the DBDC repeater AP performs load balancing by internally passing packets between two VAPs of the DBDC repeater AP. Additionally each VAP of the DBDC repeater AP may selectively transmit packets based on the radio corresponding to the packet and the radio configuration.

A method of wireless communication is described. The method may include operating, at a first radio of a repeater, in a first frequency band and receiving, at the first radio via the first frequency band, a first packet. The method may include accessing a table that identifies a first group of devices in communication with the first radio and a second group of devices in communication with a second radio of the repeater. The second radio may operate in a second frequency band different from the first frequency band. The method may include processing the first packet based at least in part on a relationship, indicated by the table, between the first packet and at least one of the first group of devices and the second group of devices.

An apparatus for wireless communication is described. The apparatus may include a DBDC repeater radio manager for operating, at a first radio of a repeater, in a first frequency band and a DBDC data receiver for receiving, at the first radio via the first frequency band, a first packet. The apparatus may include a connection table manager for accessing a table that identifies a first group of devices in communication with the first radio and a second group of devices in communication with a second radio of the repeater. The second radio may operate in a second frequency band different from the first frequency band. The apparatus may include a data processing coordinator for processing the first packet based at least in part on a relationship, indicated by the table, between the first packet and at least one of the first group of devices and the second group of devices.

A further apparatus for wireless communication is described. The apparatus may include a processor, memory in electronic communication with the processor, and instructions stored in the memory and operable, when executed by the processor, to cause the apparatus to operate, at a first radio of the apparatus, in a first frequency band and receive, at the first radio via the first frequency band, a first packet. The instructions may be operable to cause the apparatus to access a table that identifies a first group of devices in communication with the first radio and a second group of devices in communication with a second radio of the apparatus. The second radio may operate in a second frequency band different from the first frequency band. The instructions may be operable to cause the apparatus to process the first packet based at least in part on a relationship, indicated by the table, between the first packet and at least one of the first group of devices and the second group of devices.

A non-transitory computer-readable medium storing code for wireless communication is described. The code may include instructions executable to operate, at a first radio of a repeater, in a first frequency band and receive, at the first radio via the first frequency band, a first packet. The instructions may be executable to access a table that identifies a first group of devices in communication with the first radio and a second group of devices in communication with a second radio of the repeater. The second radio may operate in a second frequency band different from the first frequency band. The instructions may be executable to process the first packet based at least in part on a relationship, indicated by the table, between the first packet and at least one of the first group of devices and the second group of devices.

Some examples of the method, apparatuses, or non-transitory computer-readable medium described herein may further include processes, features, means, or instructions for identifying a first connection between the first radio of the repeater and a first radio of a root access point, the first radio of the root access point operating in the first frequency band, and identifying a second connection between the second radio of the repeater and a second radio of the root access point, the second radio of the root access point operating in the second frequency band. In some examples of the method, apparatuses, or non-transitory computer-readable medium described herein, the first radio of the repeater operates in a 24 GHz band and the second radio of the repeater operates in a 5 GHz band.

Some examples of the method, apparatuses, or non-transitory computer-readable medium described herein may further include processes, features, means, or instructions for receiving a second packet from the first radio of the root access point, and identifying a MAC address from the second packet as a source address. Some examples include determining whether the MAC address is associated with the second radio of the repeater, and detecting a presence of a packet loop based at least in part on the determination. In some examples the second packet comprises a layer two update frame or a multicast packet. Some examples of the method, apparatuses, or non-transitory computer-readable medium described herein may further include processes, features, means, or instructions for receiving a second packet from the bridge of the repeater, and passing the second packet to the second radio of the repeater.

In some examples of the method, apparatuses, or non-transitory computer-readable medium described herein, processing the first packet includes dynamically transmitting the first packet using either the first radio of the repeater or the second radio of the repeater. In some examples the first packet comprises Ethernet traffic. In some cases processing the first packet includes discarding the first packet. Additionally or alternatively, in some examples processing the first packet includes modifying a header of the first packet, and passing the first packet with the modified header to a bridge of the repeater. In some examples of the method, apparatuses, or non-transitory computer-readable medium described herein, processing the first packet includes transmitting the first packet to a first radio of a root access point that is operating in the first frequency band. Additionally or alternatively, in some examples processing the first packet includes passing the first packet to a bridge of the repeater.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

Aspects of the disclosure are described in reference to the following figures:

FIG. 1 illustrates an example of a wireless communications system that supports loop resolution and load balancing in accordance with various aspects of the present disclosure;

FIG. 2 illustrates an example of a wireless communications subsystem that supports loop resolution and load balancing in accordance with various aspects of the present disclosure;

FIG. 3 illustrates an example of a wireless communications subsystem that supports loop resolution and load balancing in accordance with various aspects of the present disclosure;

FIG. 4A illustrates an example of a wireless communications subsystem that supports loop resolution and load balancing in accordance with various aspects of the present disclosure;

FIG. 4B illustrates an example of a wireless communications subsystem that supports loop resolution and load balancing in accordance with various aspects of the present disclosure;

FIG. 4C illustrates an example of a wireless communications subsystem that supports loop resolution and load balancing in accordance with various aspects of the present disclosure;

FIG. 4D illustrates an example of a wireless communications subsystem that supports loop resolution and load balancing in accordance with various aspects of the present disclosure;

FIG. 4E illustrates an example of a wireless communications subsystem that supports loop resolution and load balancing in accordance with various aspects of the present disclosure;

FIG. 4F illustrates an example of a wireless communications subsystem that supports loop resolution and load balancing in accordance with various aspects of the present disclosure;

FIG. 4G illustrates an example of a wireless communications subsystem that supports loop resolution and load balancing in accordance with various aspects of the present disclosure;

FIG. 5 shows a block diagram of a wireless device that supports loop resolution and load balancing in accordance with various aspects of the present disclosure;

FIG. 6 shows a block diagram of a wireless device that supports loop resolution and load balancing in accordance with various aspects of the present disclosure;

FIG. 7 shows a block diagram of a wireless device that supports loop resolution and load balancing in accordance with various aspects of the present disclosure;

FIG. 8 illustrates a block diagram of a system including a DBDC repeater AP that supports loop resolution and load balancing in accordance with various aspects of the present disclosure; and

FIG. 9 illustrates a method for loop resolution and load balancing in accordance with various aspects of the present disclosure;

FIG. 10 illustrates a method for loop resolution and load balancing in accordance with various aspects of the present disclosure; and

FIG. 11 illustrates a method for loop resolution and load balancing in accordance with various aspects of the present disclosure.

### DETAILED DESCRIPTION

According to the principles of this disclosure, a dual band dual concurrent (DBDC) repeater access point (AP) uses a common connection table between two virtual access points (VAPs), each of which is associated with a different radio of the DBDC repeater AP. The connection table includes information indicating relationships between client stations and each radio. When the DBDC repeater AP receives a packet, the DBDC repeater AP may determine the source of the packet. If the source of the packet is associated with the DBDC repeater AP, the DBDC repeater AP may detect a packet loop. In one example, the DBDC repeater AP accesses the connection table to determine if the packet originated from a client associated with the DBDC repeater AP (e.g., by matching the source address to the address of a client station behind the DBDC repeater AP). A client station that has a direct connection to an AP may be referred to as being behind the AP. In another example, the DBDC repeater AP accesses the connection table to determine if the packet originated from a VAP is associated with the DBDC repeater AP.

Based on the loop detection, the DBDC repeater AP may modify the processing of subsequent packets. In some examples, the DBDC repeater AP may access the connection table to determine which radio is associated with a received packet (or packet source). The DBDC repeater AP may process the packet based on the relationship between the source client station and the radio associated with the receiving VAP. In some cases, the DBDC repeater AP may discard the packet. In other cases, the DBDC repeater AP may internally pass the packet between the two VAPs. In yet other cases, the DBDC repeater AP may transmit the packet to a corresponding VAP at a root AP. In some cases, the DBDC repeater may hand the packet from a VAP to the bridge of the DBDC repeater AP. By tailoring the processing of the packet according to its origin, the DBDC repeater AP may facilitate loop resolution and load balancing.

In some cases, one of the two radios of the DBDC repeater AP is configured as a default radio and the other radio is configured as a non-default radio. The DBDC repeater AP can dynamically configure either radio as the default radio (e.g., autonomously or based on user inputs). For example, a 2.4 GHz radio may be set as the default radio and a 5 GHz radio may be set as the non-default radio. The default radio can be set as the radio to provide the root AP link for Ethernet clients of the DBDC repeater AP. For instance, the DBDC repeater AP may send Ethernet client traffic through the VAP associated with the default radio to reach the root AP.

A packet loop may arise when both radios of the DBDC repeater AP are connected to the root AP. The DBDC repeater AP may detect a packet loop by determining if a received packet originated from the DBDC repeater AP. For example, the DBDC repeater AP may check the source address of a layer 2 update frame (L2UF) to determine whether it matches the media access control (MAC) address of a VAP at the DBDC repeater AP. In other cases, the DBDC repeater AP may determine whether a multicast packet originated from a client station behind the DBDC repeater AP. If a packet loop is detected, the DBDC repeater AP may leverage the connection table to determine how to adaptively process a packet.

For instance, subsequent to packet loop detection, the DBDC repeater AP may implement packet resolution techniques. In one example, a packet received by the DBDC repeater AP from the root AP may be processed based on the type of packet (e.g., unicast versus multicast or broadcast). Additionally, the packet may be handled differently according to which VAP (e.g., the default radio VAP versus the non-default radio VAP) receives the packet over the air. For example, when the non-default radio VAP receives multicast or broadcast packets from the root AP, the non-default radio VAP may ignore the packets and let them be processed through the default radio VAP. Alternatively, when the non-default radio VAP receives unicast packets from the root AP, the non-default radio VAP may hand the packets over to the DBDC repeater AP bridge via the default radio VAP. Hence, the bridge learns that each MAC address associated with the root AP is reachable through default radio VAP. When the default radio VAP receives any packet (e.g., unicast, multicast, or broadcast) from the root AP, the default radio may process the packet normally (e.g., the packets may be processed as if the packet loop does not exist).

Different processing techniques may be employed when the DBDC repeater AP receives a packet from a client station that is intended for the root AP. For example, when the bridge of the DBDC repeater AP gives a multicast packet to the default radio VAP, the default radio VAP will discard the packet if the source MAC address matches the MAC address of a client associated with the non-default radio. As a result, the multicast packet is transmitted if the originator of the packet belongs to the default radio VAP or the Ethernet network. On the other hand, when the bridge of the DBDC repeater AP sends a multicast packet to the non-default radio VAP, the non-default radio VAP may send the packet if the source MAC address matches the MAC address of a client associated with non-default radio. As a result, multicast packets originating from clients of the default radio or Ethernet network will be dropped.

While the DBDC repeater AP may drop multicast or broadcast packets, the DBDC repeater AP will not discard unicast packets. Instead, the DBDC may internally pass the unicast packets (e.g., between DBDC repeater VAPs) and/or transmit the unicast packets (e.g., the unicast packets may be transmitted over the 2.4 GHz radio or the 5 GHz radio to the root AP). When unicast packets are received by the DBDC repeater AP bridge that are intended for the root AP, the bridge may pass the unicast packets to the default radio VAP due to the illusion that all unicast packets are directly reachable by the default radio VAP. If a unicast packet from the bridge has a source address that matches a MAC address for a client associated with the non-default radio, the default radio VAP may pass the unicast packet to the non-default radio for transmission over the air to the root AP. Alternatively, if the unicast packet from the bridge originates from a client associated with the default radio or the Ethernet, the default radio VAP may transmit the unicast packet to the root AP.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

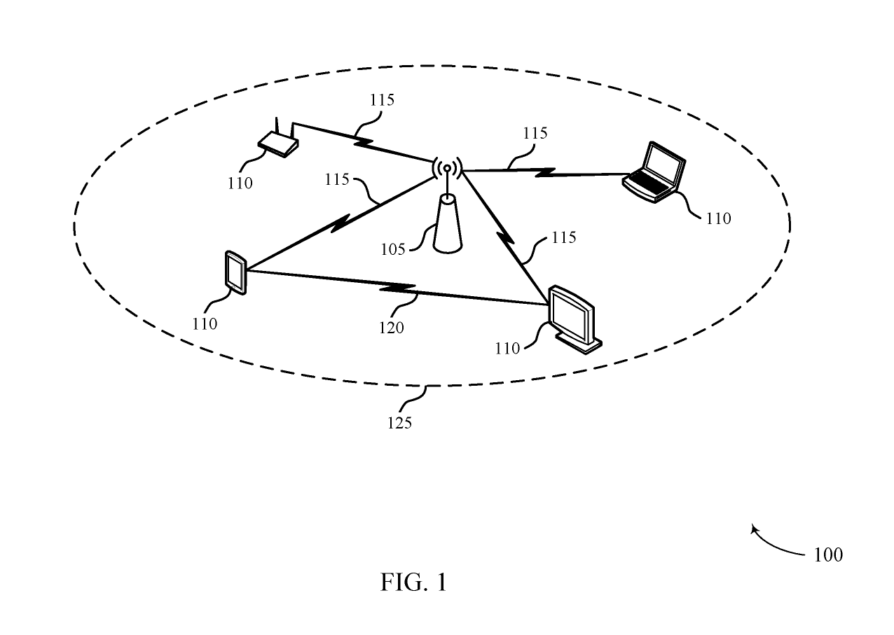

FIG. 1 illustrates an example of a wireless communications system 100 that supports loop resolution and load balancing in accordance with various aspects of the present disclosure. The wireless communications system 100 may be a wireless local area network (WLAN) that includes an access point (AP) 105 and multiple stations (STAs) 110, which may represent devices such as mobile stations, personal digital assistant (PDAs), other handheld devices, netbooks, notebook computers, tablet computers, laptops, display devices (e.g., TVs, computer monitors, etc.), printers, etc. The various STAs 110 in the network can communicate with one another through the AP 105. Also shown is a coverage area 125 of the AP 105, which may represent a basic service area (BSA) of the wireless communications system 100. The AP 105 may communicate with STAs 110 within the coverage area 125 via communication links 115.

Although not shown in FIG. 1, a STA 110 may be located in the intersection of more than one coverage area 125 and may associate with more than one AP 105. A single AP 105 and an associated set of STAs 110 may be referred to as a basic service set (BSS). An extended service set (ESS) is a set of connected BSSs. A distribution system (DS) (not shown) may be used to connect APs 105 in an ESS. In some cases, the coverage area 125 of an AP 105 may be divided into sectors (also not shown). The wireless communications system 100 may include APs 105 of different types (e.g., metropolitan area, home network, etc.), with varying and overlapping coverage areas 125. Two STAs 110 may also communicate directly via a direct wireless link 120 regardless of whether both STAs 110 are in the same coverage area 125. Examples of direct wireless links 120 may include Wi-Fi Direct connections, Wi-Fi Tunneled Direct Link Setup (TDLS) links, and other group connections. STAs 110 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within wireless communications system 100.

In some cases, the communication range of the AP 105 may be extended by using a repeater AP (not shown). The repeater AP may serve as an intermediary so that STAs 110 outside the coverage area 125 (not shown) are able to communicate with the AP 105. In some cases, the repeater AP may simultaneously use two different radios (e.g., frequencies) to connect with the AP 105. Such a repeater may be referred to as a dual band dual concurrent (DBDC) repeater AP and the AP 105 whose coverage range is enhanced may be referred to as a root AP 105. In some cases, a DBDC repeater AP may use a 2.4 GHz radio and a 5 GHz radio. However, the techniques described herein may be implemented by a DBDC repeater AP that uses other radios and frequencies. Each radio may provide communication support to client stations (e.g., STAs 110) that use the corresponding frequency. Because each radio of the DBDC repeater AP may be connected to the root AP at the same time, multicast and broadcast packets may be continually sent between the two APs. Such a scenario (referred to as a packet loop) may reduce communication efficiency and performance. Thus, a DBDC repeater AP may detect when such a loop exists and facilitate actions to provide loop termination. In some cases, the DBDC repeater AP may also perform load balancing techniques to ensure consistent radio use for communications at the DBDC repeater AP.

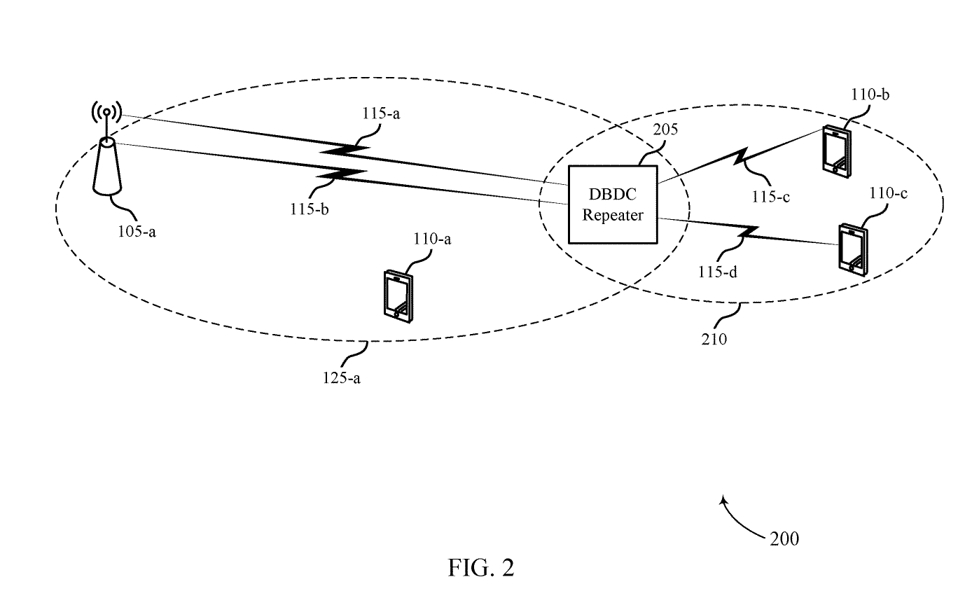

FIG. 2 illustrates an example of a wireless communications subsystem 200 that supports loop resolution and load balancing in accordance with various aspects of the present disclosure. Wireless communications subsystem 200 includes a root AP 105-a, which may be an example of an AP 105 described with reference to FIG. 1. Root AP 105-a may communicate directly with wireless devices (e.g., STA 110-a) within coverage area 125-a. Wireless communications subsystem 200 may also include a DBDC repeater AP 205, which may be an example of a DBDC repeater AP described with reference to FIG. 1. DBDC repeater AP 205 may communicate with wireless devices (e.g., STA 110-b and STA 110-c) within coverage area 210. STA 110-a, STA 110-b, and STA 110-c may be examples of STAs 110 described with reference to FIG. 1. Wireless communications subsystem 200 may detect and resolve communication loops that arise when a single root AP 105 is connected to a DBDC repeater AP 205 over two radios (e.g., radios with different operating frequencies). In some cases, wireless communications subsystem 200 may also perform load balancing.

In certain scenarios, root AP 105-a may communicate indirectly with wireless devices (e.g., STA 110-b and STA 110-c) that are outside of coverage area 125-a. For example, root AP 105-a may send a message to the DBDC repeater AP 205 which passes the message on to STAs 110 within coverage area 210. Thus, the communication range of AP 105-a may be extended by using DBDC repeater AP 205. As described above, the DBDC repeater AP 205 may support communications over two different frequency bands (e.g., a 2.4 GHz band and a 5 GHz band). In one example, the DBDC repeater AP 205 may use the 2.4 GHz band to receive messages from root AP 105-a (e.g., via communication link 115-a) and pass them to STA 110-b (e.g., via communication link 115-c). Similarly, the DBDC repeater AP 205 may use the 5 GHz band to receive messages from root AP 105-a (e.g., via communication link 115-b) and pass them to STA 110-c (e.g., via communication link 115-d).

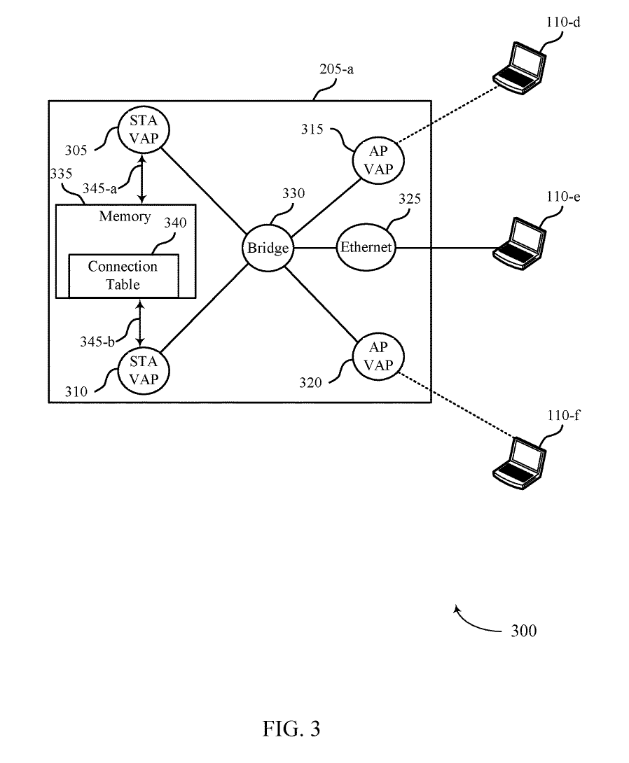

FIG. 3 illustrates an example of a wireless communications subsystem 300 that supports loop resolution and load balancing in accordance with various aspects of the present disclosure. Wireless communications subsystem 300 may include a DBDC repeater AP 205-a, which may be an example of a DBDC repeater AP 205 described with reference to FIG. 2. DBDC repeater AP 205-a may detect when a packet is experiencing a loop and perform actions to resolve the loop. DBDC repeater AP 205-a may communicate using two radios simultaneously. For example, DBDC repeater AP 205-a may concurrently communicate on both a 2.4 GHz radio and a 5 GHz radio. DBDC repeater AP 205-a may include four VAPs. A VAP may be a logical access point that is capable of communications with clients (e.g., STAs 110) or APs 105 (e.g., a root AP 105).

Each radio included in DBDC repeater AP 205-a may create two VAPs. One of the two VAPs may be a STA-VAP used for connecting DBDC repeater AP 205-a to a root AP 105. The other VAP for the radio may be an AP-VAP used for connecting clients (e.g., STAs 110) to DBDC repeater AP 205-a. Thus, there may be two VAPS (e.g., STA-VAP 305 and AP-VAP 315) that correspond to the 2.4 GHz radio and two VAPs (e.g., STA-VAP 310 and AP-VAP 320) that correspond to the 5 GHz radio. Each VAP may communicate with the bridge 330, which may connect with each communications interface in the DBDC repeater AP 205-a (e.g., STA-VAP 305, STA-VAP 310, AP-VAP 315, AP-VAP 320, and Ethernet interface 325).

A radio may be associated with the clients (e.g., STAs 110) that it serves or supports. For example, the 2.4 GHz radio maybe associated with the clients behind AP-VAP 315 (e.g., STA 110-d) and the 5 GHz radio may be associated with the clients behind AP-VAP 320 (e.g., STA 110-f). Similarly, Ethernet interface 325 may be associated with the clients that it supports over an Ethernet connection (e.g., STA 110e). In some cases, the clients corresponding to each radio may be tracked or recorded. For instance, the memory 335 included in DBDC repeater AP 205-a may include a connection table 340 that stores the relationships between the radios and their respective clients. Accordingly, in the present example, the connection table 340 may indicate that STA 110-d is associated with the 2.5 GHz radio (and therefore STA-VAP 305 and AP-VAP 315) and that STA 110-f is associated with the 5 GHz radio (and therefore STA-VAP 310 and AP-VAP 320). The connection table 340 may be common to both STA-VAP 305 and STA-VAP 310 so that each STA-VAP is aware of the clients for itself as well as the clients associated with the other STA-VAP. Each STA-VAP may be capable of accessing the connection table 340 (e.g., via links 345-a, 345-b). Thus, each STA-VAP may be aware that STA 110-d is associated with the 2.4 GHz radio and that STA 110-f is associated with the 5 GHz radio. An association or relationship may be based on a connection or communications between a STA 110 and a radio. The information stored by the connection table 340 may include identifiers (e.g., MAC addresses) for STAs 110, AP-VAPs, and STA-VAPs. For example, the connection table may include the MAC addresses of STA-VAP 305 and STA-VAP 310.

In some cases, DBDC repeater AP 205-a may balance communications by selecting one of the radios as a default radio responsible for communications with the bridge 330. The STA-VAP corresponding to the default radio may be responsible for communications with the bridge. For example, the STA-VAP that is not associated with the default radio may forego communications with the bridge 330 and route all unicast packets through the default radio STA-VAP. Additionally, the bridge 330 may refrain from communications with the non-default STA-VAP and pass packets only to the default STA-VAP. When appropriate (e.g., when the packet is to be transmitted over the non-default STA-VAP), the default STA-VAP may hand over packets from the bridge 330 to the non-default STA-VAP. Thus, the default radio STA-VAP may act as an intermediary or relay for communications between the non-default radio STA-VAP and the bridge 330.

In addition to selectively passing packets internally, the default radio STA-VAP may selectively transmit packets. The transmission of packets may be based on the radio associated with the packet and the radio configuration. For example, the default radio STA-VAP may transmit packets associated with the default radio and the non-default radio STA-VAP may transmit packets associated with the non-default radio. In some cases, the default radio STA-VAP may be responsible for transmitting traffic from Ethernet clients (e.g., STA 110-e). Accordingly, traffic associated with the default radio or the Ethernet may be transmitted by the default radio STA-VAP and traffic associated with the non-default radio may be transmitted by the non-default STA-VAP. Traffic that is not transmitted by a STA-VAP may be passed to the other STA-VAP for transmission to root AP 105-a. Thus, packet processing at a STA-VAP may be based on radio configuration.

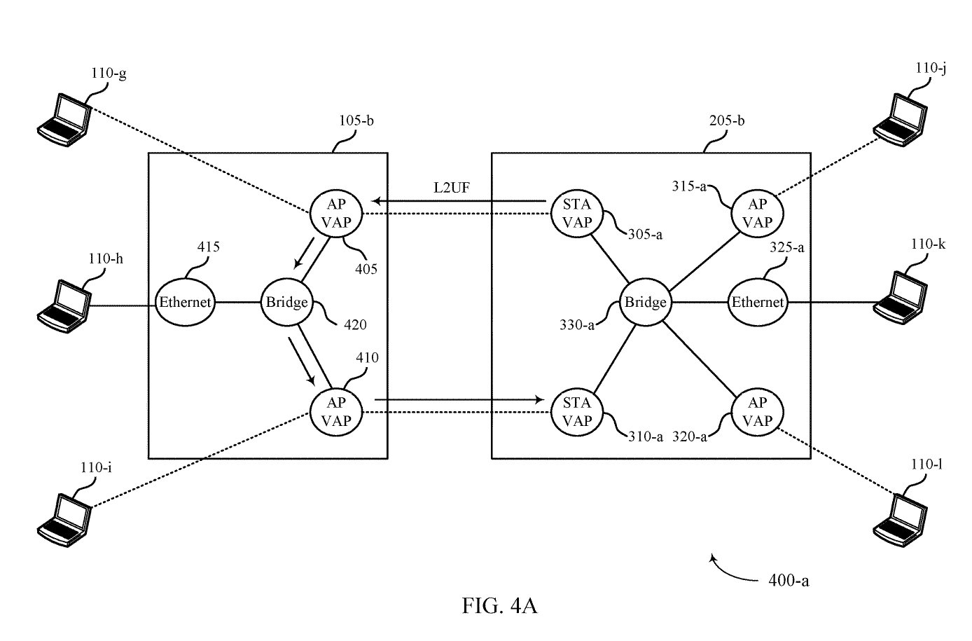

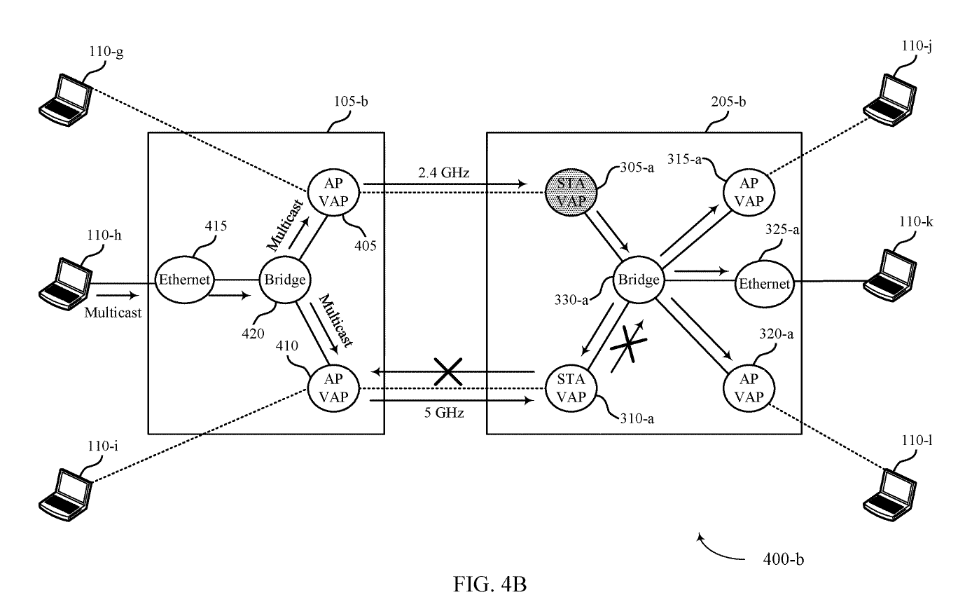

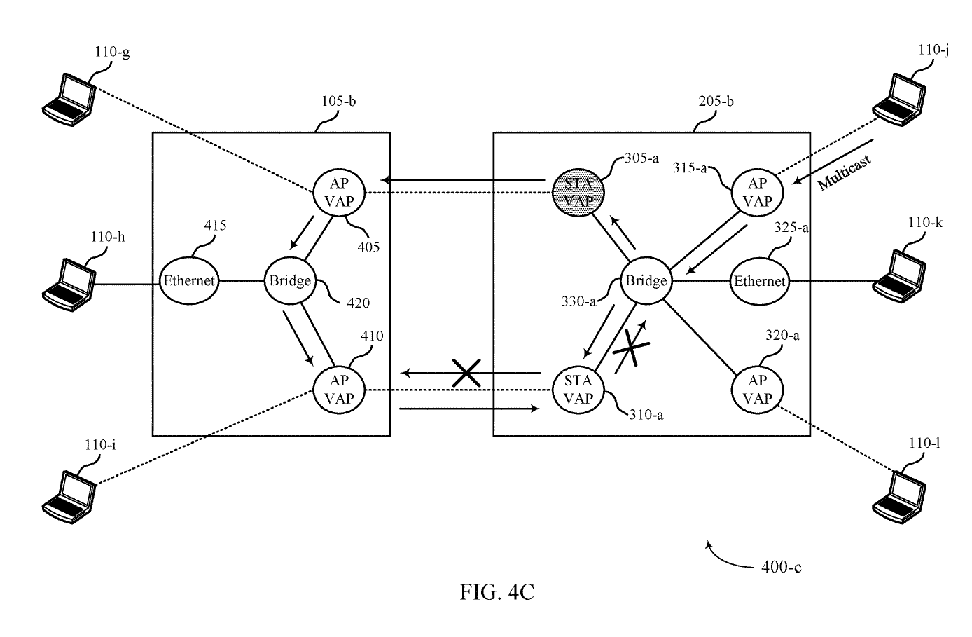

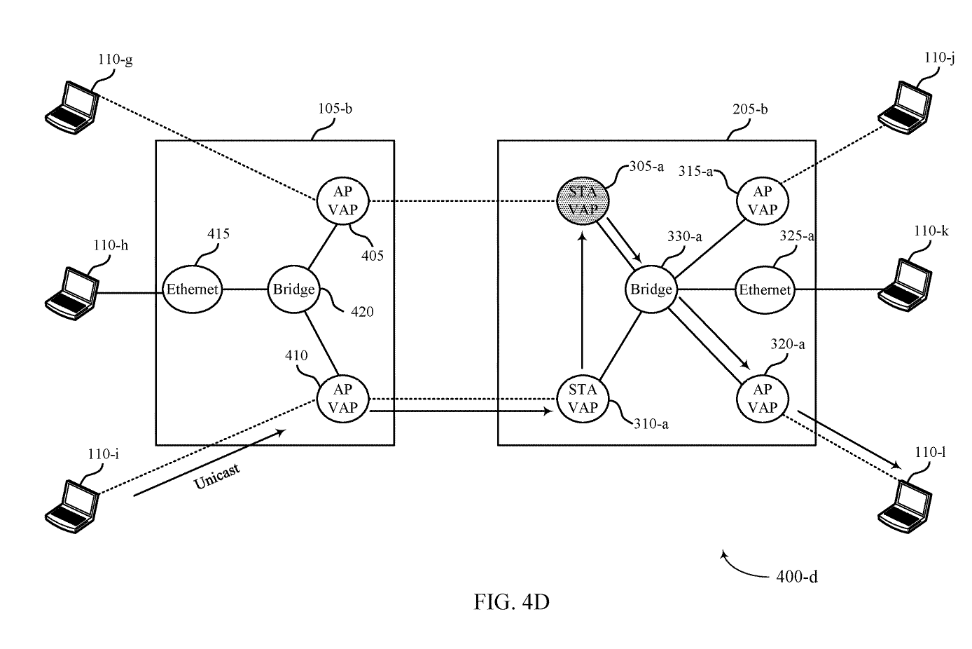

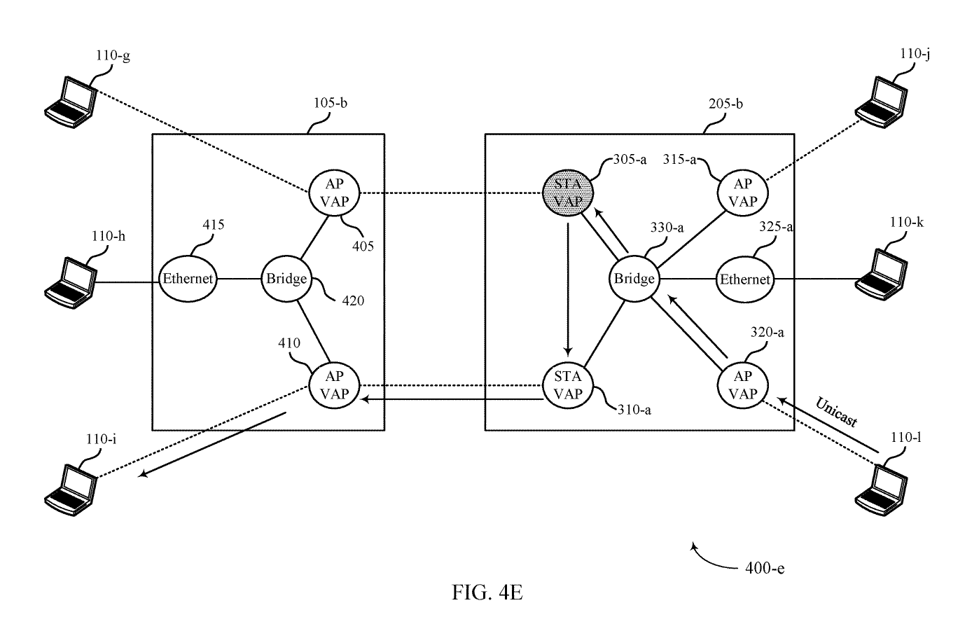

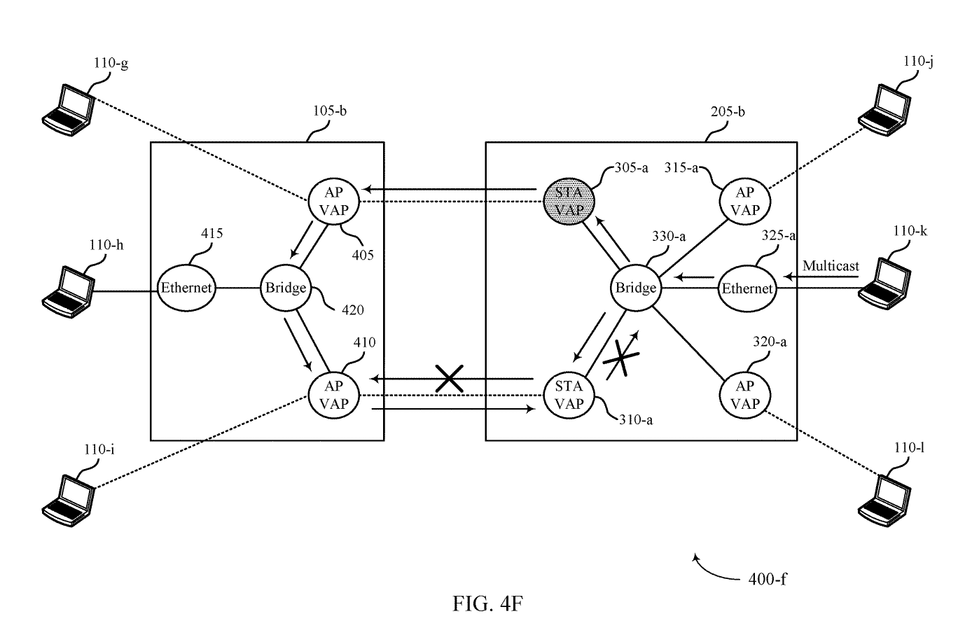

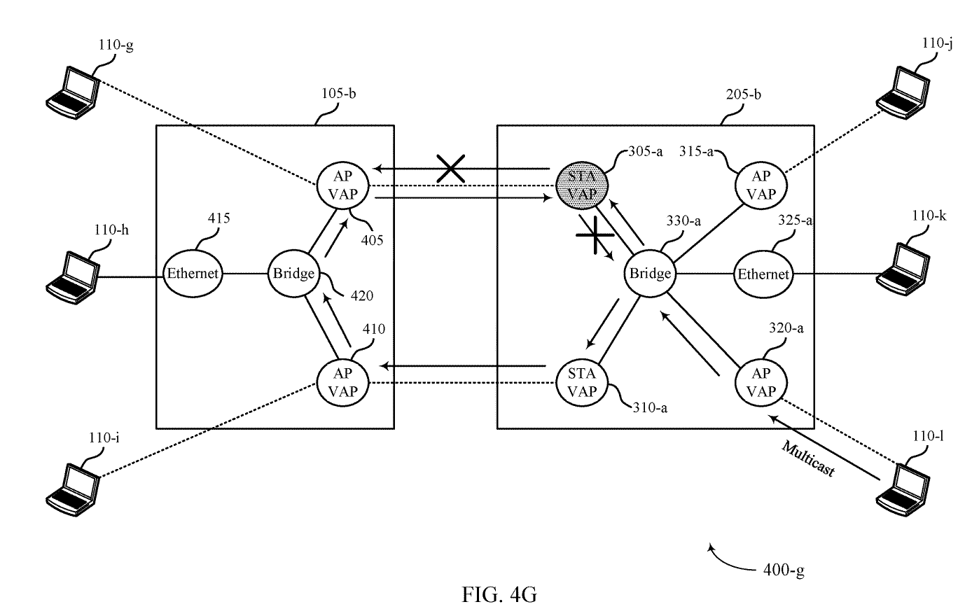

FIG. 4A illustrates an example of a wireless communications subsystem 400-a that supports loop resolution and load balancing in accordance with various aspects of the present disclosure. Wireless communications subsystem 400-a may include DBDC repeater AP 205-b which may be an example of a DBDC repeater AP 205 described with reference to FIGS. 2 and 3. Wireless communications subsystem 400-a may also include a root AP 105-b which may be an example of a root AP 105 described with reference to FIGS. 1 and 2. FIG. 4A shows one example of communications that are supported by DBDC repeater AP 205-b, root AP 105-b, and associated STAS 110.

Root AP 105-b may include two VAPs—an AP-VAP 405 and an AP-VAP 410—each of which may correspond to a different radio. AP-VAP 405 may provide connection to DBDC repeater AP 205-b by communicating with STA-VAP 305-a (e.g., via 2.4 GHz band). Similarly, AP-VAP 410 may provide connection to DBDC repeater AP 205-b by communicating with STA-VAP 310-a (e.g., via 5 GHz band). Additionally, AP-VAP 405 can support communications between STA 110-g and root AP 105-b while AP-VAP 410 can support communications between STA 110-i and root AP 105-b (e.g., by passing messages to and from the bridge 420). Although the present example shows each AP-VAP supporting a single client STA 110, an AP-VAP may support multiple client STAs 110. In some cases, the client STAs 110 supported by each AP-VAP or each AP 105 are logged in a connection table such as described with reference to FIG. 3. Ethernet interface 415 supports Ethernet communications between STA 110-h and root AP 105-b (e.g., by passing messages to and from the bridge 420).

Bridge 330-a and bridge 420 may receive unicast packets and pass them on to the appropriate communication interface (e.g., an AP-VAP, STA-VAP, or Ethernet interface). Bridge 330-a and bridge 420 may also receive multicast or broadcast packets and pass them on to appropriate connected communication interface(s). For example, a multicast (or broadcast) packet at bridge 420 may be internally passed to AP-VAP 405, AP-VAP 410, and/or Ethernet interface 415. At DBDC repeater AP 205-b, a multicast (or broadcast) packet may be passed to STA-VAP 305-a, STA-VAP 310-a, AP-VAP 315-a, AP-VAP 320-a, and/or Ethernet interface 325-a. STA-VAP 305-a, STA-VAP 310-a, AP-VAP 315-a, AP-VAP 320-a, and Ethernet interface 325-a may support the respective functions described with reference to FIG. 3.

In some cases, the dual-radio connectivity supported by root AP 105-b may result in redundant packets transmissions. For example, a packet may get caught in a loop in which it is indefinitely transmitted between root AP 105-b and DBDC repeater AP 205-b. Such a loop may be formed when STA-VAP 305-a and STA-VAP 310-a are each connected to root AP 105-b. In such a scenario, a broadcast packet passed to bridge 330-a (e.g., from STA 110-k) may be passed to STA-VAP 305-a and STA-VAP 310-a before being transmitted to AP-VAP 405 and AP-VAP 410. AP-VAP 405 and AP-VAP 410 may each pass the packet to the bridge 420, which sends the packet out on all appropriate communication interfaces (e.g., AP-VAP 405 and AP-VAP 410). Because AP-VAP 405 and AP-VAP 410 each have a connection with DBDC repeater AP 205-b,

AP-VAP 405 may transmit the packet to STA-VAP 305-a and AP-VAP 410 may transmit the packet to STA-VAP 310-a. Upon reception of each respective packet, STA-VAP 305-a and STA-VAP 310-a will each pass the packet to bridge 330-a, at which point the whole process starts over again, thereby perpetuating the packet loop.

DBDC repeater AP 205-b may recognize when a packet loop has occurred by implementing a packet loop detection scheme. In the detection scheme, after a STA-VAP (e.g., STA-VAP 305-a or STA-VAP 310-a) has established a connection with root AP 105-b, DBDC repeater AP 205-b may determine if both STA-VAP 305-a and STA-VAP 310-a are connected with root AP 105-b. If only one STA-VAP is connected to root AP 105-b, DBDC repeater AP 205-b may determine that there is no packet loop. Alternatively, if both STA-VAPs are connected to root AP 105-b, a STA-VAP may send a layer 2 update frame (L2UF) to its corresponding AP VAP (e.g., AP-VAP 405 or AP-VAP 410). An L2UF is an 802.2 logical link control (LLC) frame that includes three addresses: a transmitter address, a receiver address, and a source address. The source address may indicate the originator of the frame. DBDC repeater AP 205-b may repurpose the L2UF for loop detection by using a STA-VAP MAC address as the source address and transmitting the L2UF immediately after connecting with root AP 105-b. For instance, after STA-VAP 305-a has connected to root AP 105-b (e.g., via AP-VAP 405), STA-VAP 305-a may send an L2UF to AP-VAP 405 that includes the MAC address of STA-VAP 305-a.

Upon reception of the L2UF, AP-VAP 405 may pass the L2UF to the bridge 420. The bridge 420 may hand the L2UF over to AP-VAP 410, which transmits the L2UF to STA-VAP 310. STA-VAP 310-a may analyze the L2UF and determine that the source address corresponds to STA-VAP 305-a. This determination may be made by referencing a connection table that includes the MAC addresses of STA-VAPs for DBDC repeater AP 205-b and comparing the L2UF source address to the MAC address STA-VAP 305-a. Thus, a packet loop may be detected when an L2UF is received by the same DBDC repeater AP 205-b from which it was sent. In some cases, a similar loop detection process may be implemented that uses other broadcast or multicast frames. In such cases, a STA-VAP in DBDC repeater AP 205-b may detect a loop by determining that a multicast frame originated from the other STA-VAP at DBDC repeater AP 205-b. Thus, a packet loop can be detected when a STA-VAP associated with a first radio receives a multicast frame with the MAC address of a STA-VAP associated with a different radio.

A DBDC repeater AP 205 may use a connection table and default radio configuration to resolve a packet loop. A technique for such resolution is described in FIG. 4B which illustrates an example of a wireless communications subsystem 400-b that supports loop resolution and load balancing in accordance with various aspects of the present disclosure. Wireless communications subsystem 400-b may be an example of post-loop detection communications that are supported by root AP 105-b and DBDC repeater AP 205-b. After a packet loop has been detected (e.g., or in some cases, irrespective of packet loop detection), one of the STA-VAPs may be assigned as the default radio. The default radio may be the radio that is responsible for communication of packets originating from an Ethernet client (e.g., STA 110-h or STA 110-k). The default radio may also be solely responsible for communications with the bridge. Accordingly, packets that are passed to and from the bridge may be routed though the STA-VAP corresponding to the default radio. The radio that is not assigned as the default radio may be referred to as the non-default radio or secondary radio.

The radio configuration (e.g., which radio is assigned as the default radio) may be pre-determined or determined dynamically. The radio configuration may be autonomously determined by DBDC repeater AP 205-b or indicated by an external entity (e.g., by a user or root AP 105-b, etc.). In the present example, the 2.4 GHz radio is selected as the default radio and the 5 GHz radio is the non-default radio. However, the techniques described herein may also be implemented when the 5 GHz radio is selected as the default radio and the 2.4 GHz radio is the non-default radio.

After a packet loop has been detected, root AP 105-b may have multicast (or broadcast) communications to send to DBDC repeater AP 205-b. For example, the bridge 420 may receive a multicast packet from STA 110-h. Accordingly, the bridge 420 may pass the multicast packet to AP-VAP 405 and AP-VAP 410. AP-VAP 410 may transmit the multicast packet to STA-VAP 310-a using the 5 GHz band and AP-VAP 405 may transmit the multicast packet to STA-VAP 305-a using the 2.4 GHz band. The default radio STA-VAP 305-a may pass the multicast packet to bridge 330-a. However, the non-default radio STA-VAP 310-a may ignore the multicast packet and refrain from passing it to bridge 330-a. In one example, STA-VAP 310-a may drop the multicast packet. The decision to drop the packet may be based on the determination that a packet loop has been detected, that STA-VAP 310-a corresponds to the non-default radio, and that the packet is multicast.

Thus, bridge 330-a may receive the multicast packet from STA-VAP 305-a and not from STA-VAP 310-a. Upon reception of the multicast packet, bridge 330-a may pass the multicast packet to each relevant communication interface (e.g., AP-VAP 315-a, AP-VAP 320-a, Ethernet interface 325-a, and STA-VAP 310-a). Each communication interface that receives the multicast packet may transmit the multicast packet to the corresponding target client. That is, AP-VAP 315-a may transmit the multicast packet via the 2.4 GHz band to STA 110-j, AP-VAP 320-a may transmit the multicast packet via the 5 GHz band to STA 110-1, and the Ethernet interface may send the packet over a wired connection to STA 110-k. However, instead of transmitting the multicast packet to AP-VAP 410 (and thus perpetuating a packet loop), STA-VAP 310-a may refrain from transmission and drop the multicast packet. Thus, packets may be solely processed by STA-VAP 305-a so that STA-VAP 310-a may serve as a break in the packet loop.

In some cases, a multicast packet may originate from the side of DBDC repeater AP 205-b. In such instances, packet loop resolution may be employed such as shown FIG. 4C which illustrates an example of a wireless communications subsystem 400-c that supports loop resolution and load balancing in accordance with various aspects of the present disclosure. Wireless communications subsystem 400-c may support techniques for packet loop resolution when multicast packets originate from DBDC repeater AP 205-b and are intended for clients behind root AP 105-b.

In the present example, the default radio is the 2.4 GHz radio and STA 110-j has a multicast (or broadcast) packet intended for clients behind AP 105-b. Accordingly, STA 110-j transmits the multicast packet over the 2.4 GHz band to AP-VAP 315-a which passes the multicast packet to bridge 330-a. Bridge 330-a may pass the multicast packet to appropriate communication interfaces such as STA-VAP 305-a and STA-VAP 310-a. STA-VAP 305-a may determine the origin or source of the multicast packet and adjust its processing accordingly. For example, if the multicast packet originates from a client associated with the non-default radio (e.g., STA 110-l) STA-VAP 305-a may discard the packet. If the multicast packet originates from a client associated with the default radio (e.g. STA 110-j) or a client associated with Ethernet interface 325-a (e.g., STA 110-k), STA-VAP 305-a may elect to transmit the packet over the 2.4 GHz band to AP-VAP 405. In summary, STA-VAP 305-a may transmit a multicast packet to AP-VAP 405 if the source of the multicast packet belongs to the default radio's AP-VAP or the Ethernet network. STA-VAP 305-a may determine the relationship between the packet and the default radio by accessing a connection table such as described in FIG. 3. In this example, the multicast packet originates from a client behind the default radio and so STA-VAP 305-a transmits the multicast packet to AP-VAP 405.

STA-VAP 310-a may also base processing decisions on the relationship between the multicast packet and a radio. For example, STA-VAP 310-a may discard the multicast packet from bridge 330-a if the source of the multicast packet is a client associated with the default radio (e.g., STA 110-j) or a client associated with Ethernet interface 325-a (e.g., STA 110-k). On the other hand, STA-VAP 310-a may transmit the multicast packet to AP-VAP 410 if the source of the multicast packet is associated with the non-default radio (e.g., STA 110-l). To summarize, multicast packets that are received by the non-default STA-VAP and that originate from a client of the default radio or the Ethernet network will be discarded. In the present example, STA-VAP 310-a determines that the multicast packet is associated with the default radio and refrains from transmitting the multicast packet to AP-VAP 410. STA-VAP 310-a may determine the relationship between radios, clients, and multicast packets by accessing or querying a connection table such as described with reference to FIG. 3.

After AP-VAP 405 receives the multicast packet from default radio STA-VAP 305-a, AP-VAP 405 may pass the multicast packet to the bridge 420. The bridge 420 may pass the multicast packet to each relevant communication interface, including AP-VAP 410. In turn, AP-VAP 410 may transmit the multicast packet (using the non-default radio frequency) to STA-VAP 310-a. Upon reception of the multicast packet, STA-VAP 310-a may determine the source of the multicast packet. If the source is a client station associated with the default radio (or Ethernet) then STA-VAP 310-a may refrain from passing the multicast packet to bridge 330-a (e.g., STA-VAP 310-a may discard the multicast packet). On the other hand, if the source is a client station associated with the non-default radio then STA-VAP 310-a may pass the multicast packet to bridge 330-a.

In addition to resolving packet loops, a DBDC repeater AP 205 may also implement load balancing. FIG. 4D illustrates an example of a wireless communications subsystem 400-d that supports loop resolution and load balancing in accordance with various aspects of the present disclosure. Wireless communications subsystem 400-d may support techniques for load distribution when both STA-VAPs in a DBDC repeater AP 205 are connected to a root AP 105-b. For example, unicast packets may be routed through the STA-VAP associated with the default radio. The default radio STA-VAP may analyze packets to determine which radio interface should be used for sending the packets to the root AP 105. In some cases, the same radio used to communicate the packets to the DBDC repeater AP 205-b is used to transmit the packets to the root AP 105. For instance, traffic from clients connected with the first radio (e.g., a 2.4 GHz radio) may use only the first radio to reach the root AP 105. Similarly, traffic from clients connected with the second radio (e.g., a 5 GHz radio) may use only the second radio to reach the root AP 105. In the present example, the first radio (e.g., the 2.4 GHz) is selected as the default radio.

Bridge 330-a may keep a connection table that logs which communication interfaces are used to communicate each client. By updating and referencing this table, bridge 330-a may know which STA-VAP is capable of reaching a client and may pass unicast packets to the STA-Attorney

VAP accordingly. For example, if a unicast packet from STA 110-i is received by bridge 330-a from STA-VAP 310-a, bridge 330-a may update the connection table to indicate that STA 110-i is reachable via STA-VAP 310-a. Accordingly, bridge 330-a may pass any unicast packet intended for STA 110-i to STA-VAP 310-a. DBDC repeater AP 205-a may use the features of the connection table to ensure that a unicast packet is communicated over the air using the appropriate radio. For example, DBDC repeater AP 205-b may implement load balancing by internally passing unicast packets between the STA-VAPs. Consequently, bridge 330-a may update the connection table to associate a client with a STA-VAP that was not the original, over-the-air recipient of the unicast packet.

In some cases, a client of root AP 105-b may be associated with the non-default radio and may have unicast data for a client of DBDC repeater AP 205-b that is associated with the non-default radio. For instance, STA 110-i may have a unicast packet intended for STA 110-l. Accordingly, STA 110-i may transmit the unicast packet over the 5 GHz radio to AP-VAP 410. AP-VAP 410 may transmit the unicast packet over the 5 GHz radio to STA-VAP 310-a. In an effort to implement load balancing STA-VAP 310-a may internally pass the unicast packet to STA-VAP 305-a instead of passing it directly to bridge 330-a. In some cases, internally passing the unicast packet to STA-VAP 305-a may include modifying header information of the unicast packet to indicate that the unicast packet comes from STA-VAP 305-a. After reception of the unicast packet, STA-VAP 305-a may pass the unicast packet to bridge 330-a. Thus, bridge 330-a may associate STA 110-i with STA-VAP 305-a, even though STA 110-i and STA-VAP 305-a use different radios. To finish the communication process, bridge 330-a may pass the unicast packet to AP-VAP 320-a which transmits the unicast packet over the 5 GHz radio to target recipient STA 110-l. Thus, a single radio is used to transmit the unicast packet from STA 110-i to root AP 105-a, from root AP 105-b to DBDC repeater AP 205-a, and from DBDC repeater AP 205-a to STA 110-l.

Although not shown, there may be instances when a client of root AP 105-b that is associated with the default radio has unicast data for a client of DBDC repeater AP 205-b that is associated with the default radio. For instance, STA 110-g may have unicast data for STA 110-j. Because both of these STAs 110 use the default radio, the unicast packet may be passed directly to bridge 330-a (e.g., there may not be an internal passing of the unicast date between STA-VAPs). For example, STA-VAP 305-a may receive the unicast data from AP-VAP 405 and pass it directly to bridge 330-a. Therefore, only the default radio band may be used for over-the-air transmissions of the unicast data.

Thus, a DBDC repeater AP 205 may implement internal communications between STA-VAPs to facilitate load balancing. Such internal communications may allow a single STA-VAP (e.g., the STA-VAP for the default radio) to be solely responsible for the communication of unicast packets to and from the DBDC bridge 330-a. For instance, when a unicast packet from a root AP 105 is received on the STA-VAP associated with the non-default radio, the unicast packet can be handed over to the bridge via the default radio STA-VAP interface. Alternatively, when a unicast packet from the root AP 105 is received on the STA-VAP associated with the default radio, the STA-VAP can handle the unicast packet directly.

In some cases, a DBDC repeater AP client associated with the non-default radio may have unicast data for a root AP client that is also associated with the non-default radio. Such a scenario is shown in FIG. 4E which illustrates an example of a wireless communications subsystem 400-e that supports loop resolution and load balancing in accordance with various aspects of the present disclosure. In the present example, STA 110-l has unicast data for STA 110-i. Accordingly, STA 110-l may transmit the unicast data (using the non-default radio) to AP-VAP 320-a. AP-VAP 320-a may, in turn, pass the unicast data to bridge 330-a. Bridge 330-a may reference the connection table to determine which STA-VAP is associated with STA 110-i. The connection table may have been updated to include the transactions from FIG. 4D. Accordingly, bridge 330-a may determine that it previously received a unicast packet originating at STA 110-i from STA-VAP 305-a. Due to this association, bridge 330-a may hand the unicast data to STA-VAP 305-a instead of STA-VAP 310-a.

Upon reception of the unicast data, STA-VAP 305-a may determine which radio is associated with the unicast data. In some cases, this process may involve determining the source station for the unicast data and the radio corresponding to that station (e.g., STA-VAP 305-a may access the connection table). STA-VAP 305-a may process the unicast data based on the radio association determination. In this example, STA-VAP 305-a determines that the unicast data corresponds to the non-default radio and passes the unicast data to STA-VAP 310-a for transmission over the non-default radio to AP-VAP 410. AP-VAP 410 may finish the communication chain by transmitting the unicast data over the non-default radio to STA 110-i.

A DBDC repeater AP client associated with the default radio may have unicast data for a root AP client associated with the non-default radio. For example, STA 110-j may have unicast data for STA 110-i. In such a scenario, STA 110-j may transmit the unicast data over the default radio to AP-VAP 315-a which passes the unicast data to bridge 330-a. Bridge 330-a may determine that STA 110-i is reachable via STA-VAP 305-a and pass the unicast data over accordingly. STA-VAP 305-a may determine the radio associated with the unicast data (e.g., by accessing the connection table) and process the packet based on the association. In the present example, STA-VAP 305-a may determine that the unicast data is associated with the default radio and transmit the unicast data over the default radio to AP-VAP 405. Thus, a single radio is used to transmit the unicast data from a client behind DBDC repeater AP 205-b to root AP 105-b. AP-VAP 405 may pass the unicast data to bridge 420, which in turn may hand the unicast data to AP-VAP 410. AP-VAP 410 may finish the communication chain by transmitting the unicast data to STA 110-i using the non-default radio associated with STA 110-i.

A similar process may be used when a DBDC repeater AP client associated with the default radio has unicast data for a default radio client behind a root AP. For example, STA 110-j may has unicast data intended for STA 110-g. In this case, the process may be the same as above until after AP-VAP 405 receives the unicast data from STA-VAP 305-a over the default radio. In the new scenario, AP-VAP 405 may send the data directly to STA 110-g using the default radio rather than passing the uncast data to bridge 420.

FIG. 4F illustrates an example of a wireless communications subsystem 400-f that supports loop resolution and load balancing in accordance with various aspects of the present disclosure. Wireless communications subsystem 400-f shows an example of how multicast packets from an Ethernet client are handled by a DBDC repeater AP 205-b when a packet loop has been detected. In the present example, STA 110-k has multicast data for a client or clients behind root AP 105-b (e.g., STA 110-g, STA 110-h, and/or STA 110-i). Accordingly, STA 110-k sends the multicast data to the Ethernet interface 325-a, which passes the multicast data to bridge 330-a. Bridge 330-a may send the multicast data to default radio STA-VAP 305-a and non-default radio STA-VAP 310-a.

For the non-default radio, STA-VAP 310-a may determine that the multicast data is Ethernet traffic (e.g., originates from an Ethernet client station) and refrain from transmitting the multicast data to AP-VAP 410 (e.g., STA-VAP 310-a may ignore or drop the multicast data). For the default radio, STA-VAP 305-a may determine that the multicast data originates from an Ethernet client station and transmit the multicast data to AP-VAP 405. The STA-VAPs may determine the origin of the multicast data by referencing the source address and using it to query a connection table. The multicast data may be passed from AP-VAP 405 to bridge 420 and from bridge 420 to AP-VAP 410 before being transmitted to STA-VAP 310-a. Upon reception of the multicast data from AP-VAP 410, STA-VAP 310-a may use the connection table to determine that the multicast data is associated with a source Ethernet client station. Based on the determination, STA-VAP 310-a may discard the multicast data. Thus, STA-VAP 310-a may resolve or prevent a packet loop by dropping multicast data from clients unassociated with the non-default radio.

FIG. 4G illustrates an example of a wireless communications subsystem 400-g that supports loop resolution and load balancing in accordance with various aspects of the present disclosure. Wireless communications subsystem 400-g shows an example of how multicast packets from a client associated with the non-default radio are handled by a DBDC repeater AP 205-b when a packet loop has been detected. In the present example, STA 110-l has multicast data for a client or clients behind root AP 105-b (e.g., STA 110-g, STA 110-h, and/or STA 110-i). Accordingly, STA 110-l may transmit the multicast data to AP-VAP 320-a using the non-default radio frequency. AP-VAP 320-a may pass the multicast data to bridge 330-a, which may pass the multicast data to STA-VAP 305-a and STA-VAP 310-a. STA-VAP 305-a may determine that the multicast data is from a client associated with the non-default radio (e.g., by referencing a connection table) and discard the data. STA-VAP 310-a may also determine that the multicast data is from a client associated with the non-default radio (e.g., by referencing the same connection table) and transmit the multicast data to AP-VAP 410 over the non-default radio.

Upon reception of the multicast data, AP-VAP 410 may pass the multicast data over to bridge 420, which in turn may pass the multicast data to AP-VAP 405. AP-VAP 405 may transmit the multicast data to STA-VAP 305-a. However, instead of blindly passing the multicast data to bridge 330-a, STA-VAP 305-a may first determine the source (origin) of the multicast data and the radio associated with that source (e.g., STA-VAP 305-a may use the connection table). STA-VAP 305-a may process the multicast packet based on the relationship information included in the connection table. For example, if the source of the multicast data is associated with the default radio, STA-VAP 305-a may pass the multicast data to bridge 330-a. However, in this example, the source of the multicast data is associated with the non-default radio; therefore STA-VAP 305-a does not pass the multicast data to bridge 330-a. In summary, a default STA-VAP may relay multicast data that is associated with the default radio or the Ethernet and drop multicast data that is associated with the non-default radio. A non-default STA-VAP may relay multicast data that is associated with the non-default radio and discard multicast data associated with the default radio or the Ethernet.

Each of the loop resolution and load balancing techniques described with reference to FIGS. 4B-4G may be implemented after a packet loop has been detected (e.g., using the techniques described with reference to FIG. 4A). A DBDC repeater AP 205 may implement such techniques when both radios of the DBDC repeater AP 205 are simultaneous connected with a root AP 105. The DBDC repeater AP 205 may discontinue such techniques when one or both of the connections are dropped.

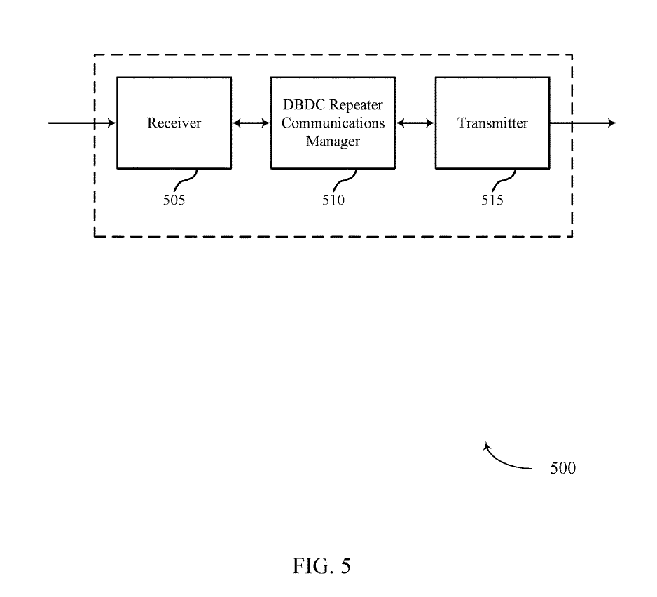

FIG. 5 shows a block diagram of a wireless device 500 configured for DBDC loop resolution and load balancing in accordance with various aspects of the present disclosure. Wireless device 500 may be an example of aspects of a DBDC repeater AP 205 described with reference to FIGS. 1-4G. Wireless device 500 may include a receiver 505, a DBDC repeater communications manager 510, and/or a transmitter 515. Wireless device 500 may also include a processor. Each of these components may be in communication with each other.

The receiver 505 may receive information such as packets (e.g., multicast, broadcast, unicast packets), user data, or control information associated with various information channels (e.g., control channels, data channels, etc.). Information (e.g., information related to dual band dual concurrent loop resolution and load balancing, etc.) may be passed on to the DBDC repeater communications manager 510, and to other components of wireless device 500.

The DBDC repeater communications manager 510 may facilitate operations of a first radio of the wireless device 500. The first radio may operate in a first frequency band (e.g., the first radio may operate at 2.4 GHz). The DBDC repeater communications manager 510 may also facilitate operations of a second radio of the wireless device 500. The second radio may operate in a second frequency band (e.g., the second radio may operate at 5 GHz). In some cases, the DBDC repeater communications manager 510 may receive (e.g., at the first radio via the first frequency band) a first packet. The packet may be a multicast, broadcast, or unicast packet. The DBDC repeater communications manager 510 may access a table (e.g., a connection table) that identifies a first group of devices in communication with the first radio and a second group of devices in communication with a second radio of the wireless device 500. In some cases, the table may indicate or identify a relationship between the first packet and a group of devices. The DBDC repeater communications manager 510 may determine how to process the first packet based at least in part on this relationship. In some cases, the processing of the packet facilitates load balancing. In other cases, the processing of the packet may facilitate packet loop resolution.

The transmitter 515 may transmit signals received from other components of wireless device 500. In some examples, the transmitter 515 may be collocated with the receiver 505 in a transceiver module. The transmitter 515 may include a single antenna, or it may include a plurality of antennas.

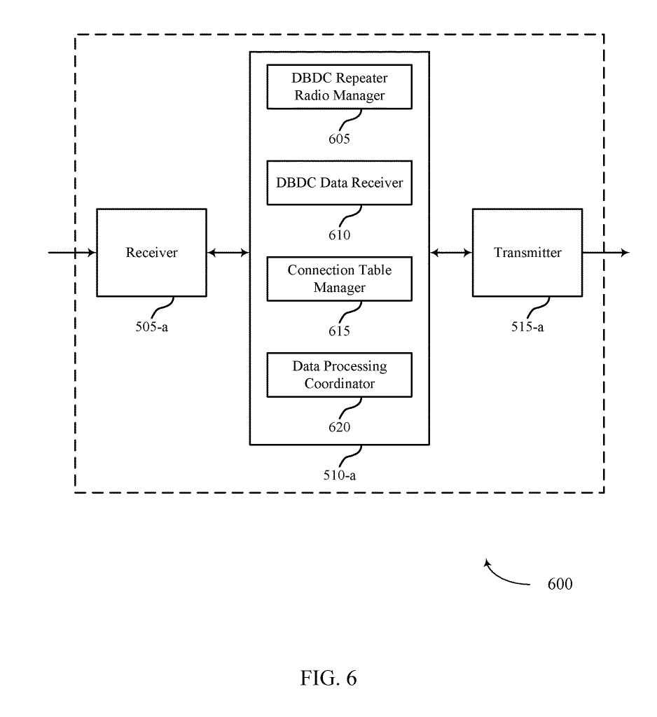

FIG. 6 shows a block diagram of a wireless device 600 for DBDC loop resolution and load balancing in accordance with various aspects of the present disclosure. Wireless device 600 may be an example of aspects of a wireless device 500 or a DBDC repeater AP 205 described with reference to FIGS. 1-5. Wireless device 600 may include a receiver 505-a, a DBDC repeater communications manager 510-a, or a transmitter 515-a. Wireless device 600 may also include a processor. Each of these components may be in communication with each other. The DBDC repeater communications manager 510-a may include a DBDC repeater radio manager 605, a DBDC data receiver 610, a connection table manager 615, and a data processing coordinator 620.

The receiver 505-a may receive information which may be passed on to DBDC repeater communications manager 510-a, and to other components of wireless device 600. The DBDC repeater communications manager 510-a may perform the operations of a DBDC repeater communications manager 510 as described with reference to FIG. 5. The transmitter 515-a may transmit signals received from other components of wireless device 600.

The DBDC repeater radio manager 605 may facilitate operations at two radios of the wireless device 600 as described with reference to FIGS. 2-4G. One of the radios may operate in a first frequency band and the other radio may operate in a second frequency band (e.g., the first radio may operate in a 2.4 GHz band and the second radio may operate in a 5 GHz band). The DBDC repeater radio manager 605 may facilitate connections and communications between the radios and other wireless devices (e.g., APs 105 or STAs 110). In some cases, the DBDC repeater radio manager 605 may facilitate the configuration of the first radio as a default radio and the second radio as a non-default radio (or vice versa).

The DBDC data receiver 610 may facilitate reception of a first packet at the first radio via the first frequency band, as described with reference to FIGS. 2-4G. For example, the DBDC data receiver 610 may, in conjunction with the receiver 505-a, facilitate the reception of unicast, multicast, or broadcast packets. In some cases, the packets are received over the air (e.g., using one of the two radios). In other cases, the packets are received via an internal handover (e.g., the packets may be passed from other components of the wireless device 600). In some cases, the DBDC data receiver 610 may facilitate reception of a packet from a root AP 105. In some cases, the DBDC data receiver 610 may also facilitate reception of a packet from the bridge (not shown) of the wireless device 600. In some examples, the received packet is a layer two update frame. In some examples, the received packet includes Ethernet traffic. The DBDC data receiver 610 may pass data (e.g., received packets) or information to other components of the wireless device 600.

The connection table manager 615 may access a table (e.g., a connection table) that identifies a group of devices in communication with the first radio and a group of devices in communication with the second radio of the wireless device 600. For example, the connection table manager 615 may reference the connection table to determine which MAC address is associated with each radio. In some cases, the connection table manager 615 may determine whether a MAC address associated with a received packet corresponds to the second radio of the wireless device 600.

As described above, the connection table may indicate the relationships between packets, clients, and/or radios. For example, the connection table may identify the stations (e.g., by their MAC addresses) that are supported or served by each radio. In some cases, the connection table may indicate the relationship between a received packet and a client station. Accordingly, the data processing coordinator 620 may process received packets based at least in part on the relationships indicated by the connection table. In some examples, processing a received packet includes modifying a header of the packet and/or passing the packet to another component of the wireless device 600. For example, the data processing coordinator 620 may facilitate passing a packet with a modified header from a STA-VAP to the bridge of the wireless device 600. The modified header may indicate the component from which the packet was passed. In some cases, the data processing coordinator 620 may facilitate passing a packet from one STA-VAP to another STA-VAP within the wireless device 600 (e.g., the data processing coordinator 620 may facilitate passing a received packet to the second radio of the wireless device 600). In some examples, processing a received packet includes dynamically transmitting the packet using one of the configured radios. For example, the data processing coordinator 620 may facilitate transmitting a packet from a STA-VAP at the wireless device 600 to an AP-VAP at a root AP 105. In some cases, processing a received packet includes transmitting the packet to a first radio of a root access point that is operating in the first frequency band. In some examples, processing the first packet includes discarding the first packet. For instance, the data processing coordinator 620 may facilitate dropping a received packet by a STA-VAP at the wireless device 600.

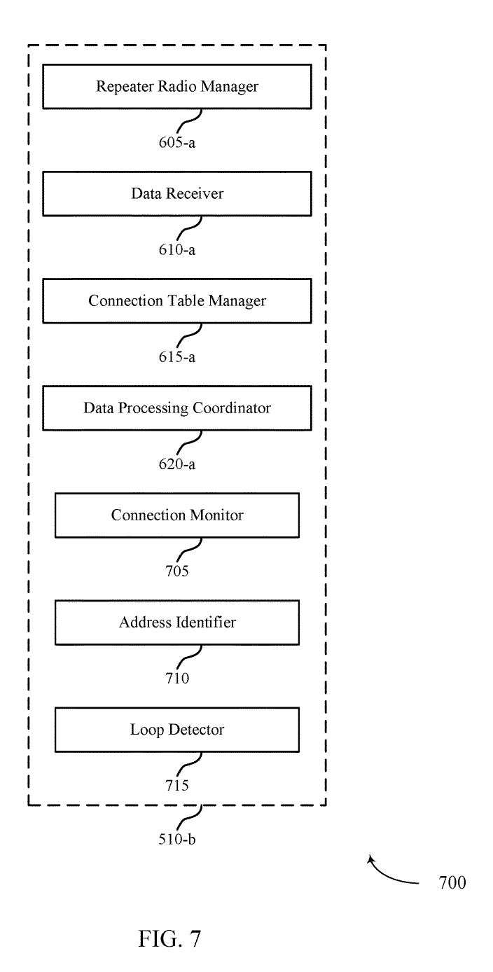

FIG. 7 shows a block diagram 700 of a DBDC repeater communications manager 510-b which may be a component of a wireless device 500 or a wireless device 600 for DBDC loop resolution and load balancing in accordance with various aspects of the present disclosure. The DBDC repeater communications manager 510-b may be an example of aspects of a DBDC repeater communications manager 510 or 510-b described with reference to FIGS. 5 and 6, respectively. The DBDC repeater communications manager 510-b may include a DBDC repeater radio manager 605-a, a DBDC data receiver 610-a, a connection table manager 615-a, and a data processing coordinator 620-a. Each of these modules may perform the functions described with reference to FIG. 6. The DBDC repeater communications manager 510-b may also include a connection monitor 705, an address identifier 710, and a loop detector 715.

The connection monitor 705 may identify a first connection between the first radio of the wireless device and a first radio of a root AP 105. The first radio of the root AP 105 may operate in the first frequency band as described with reference to FIGS. 2-4G. The connection monitor 705 may also identify a second connection between the second radio of the wireless device and a second radio of the root AP 105. The second radio of the root AP 105 may operate in the second frequency band. In some cases, the connection monitor 705 may indicate the identified connections to other components of wireless device. In some examples, the connection monitor 705 may instigate the transmission of L2UF packets to a root AP 105 (e.g., by reporting when a connection is established between a STA-VAP of the wireless device and an AP-VAP of the root AP 105). The connection monitor 705 may also detect when a connection between the wireless device and a root AP 105 is lost. In such a scenario, the connection monitor 705 may indicate that there is no potential for a packet loop so that regular packet flow processing is used (e.g., instead of processing that facilities loop resolution or load balancing).

The address identifier 710 may identify MAC addresses from received packets. In some cases, the address identifier 710 may identify the source address of an L2UF packet as the MAC address for a STA-VAP of the wireless device. In other cases, the address identifier 710 may detect that a multicast packet is from a client served by one of the radios of the wireless device. The address identifier 710 may pass this information to other components of the wireless device. For example, the address identifier 710 may communicate the MAC address information to the loop detector 715. Based on this information, the loop detector 715 may detect the presence of a packet loop as described with reference to FIGS. 2-4G.

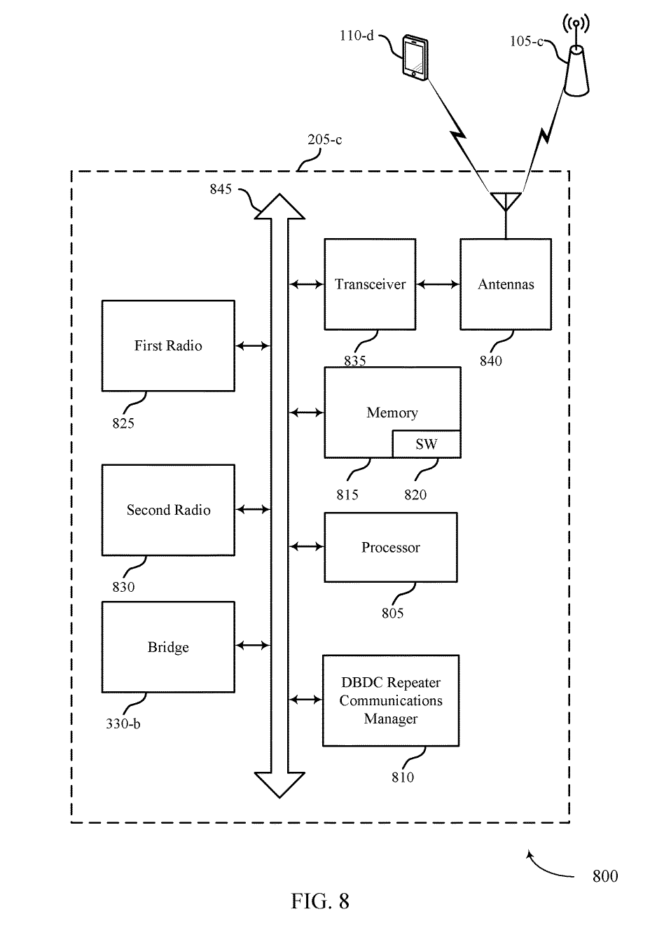

FIG. 8 shows a diagram of a system 800 including a DBDC repeater AP 205-c configured for DBDC loop resolution and load balancing in accordance with various aspects of the present disclosure. DBDC repeater AP 205-c may be an example of a DBDC repeater AP 205, a wireless device 500, or a wireless device 600 described with reference to FIGS. 2-6. DBDC repeater AP 205-c may include a DBDC repeater communications manager 810, which may be an example of a DBDC repeater communications manager 510 described with reference to FIGS. 5-7. DBDC repeater AP 205-c may also include components for bi-directional voice and data communications including components for transmitting communications and components for receiving communications. For example, DBDC repeater AP 205-c may communicate bi-directionally with STA 110-d or root AP 105-c. In some cases, DBDC repeater AP 205-c may expand the coverage range of root AP 105-c by relaying communications between root AP 105-c and STA 110-d.

DBDC repeater AP 205-c may include a processor 805, and memory 815 (including software (SW) 820), a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may be used to communicate bi-directionally with root AP 105-c or STA 110-d. The transceiver 835 may include a modem to modulate the packets and provide the modulated packets to the antenna(s) 840 for transmission, and to demodulate packets received from the antenna(s) 840. While DBDC repeater AP 205-c may include a single antenna 840, DBDC repeater AP 205-c may also have multiple antennas 840 capable of concurrently transmitting or receiving multiple wireless transmissions. In some examples, DBDC repeater AP 205-c may include two radios for simultaneous transmissions over two different frequency bands. For example, DBDC repeater AP 205-c may use first radio 825 to communicate over a first frequency band (e.g., 2.4 GHz) and second radio 830 to communicate over a second frequency band (e.g., 5 GHz). DBDC repeater AP 205-c may also include bridge 330-c, which may connect with each communications interface in the DBDC repeater AP 205-c and which may perform aspects of the loop detection and load balancing techniques described herein.

The memory 815 may include random access memory (RAM) and read only memory (ROM). In some cases, the memory 815 is an example of the memory 335 described with reference to FIG. 3. For example, the memory 815 may include a connection table that indicates the relationships between clients and VAPs. In some cases, the connection table includes identification information (e.g., MAC addresses) for clients (e.g., STAs 110), APs (e.g., root APs 105, DBDC repeater APs 205), STA-VAPs, and/or AP-VAPs. The memory 815 may store computer-readable, computer-executable software/firmware code 820 including instructions that, when executed, cause the processor 805 to perform various functions described herein (e.g., dual band dual concurrent loop resolution and load balancing, etc.). Alternatively, the software/firmware code 820 may not be directly executable by the processor 805 but may cause a computer (e.g., when compiled and executed) to perform functions described herein. The processor 805 may include an intelligent hardware device, (e.g., a central processing unit (CPU), a microcontroller, an application specific integrated circuit (ASIC), etc.).

The components of DBDC repeater AP 205-c, wireless device 500, wireless device 600, and DBDC repeater communications manager 810 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

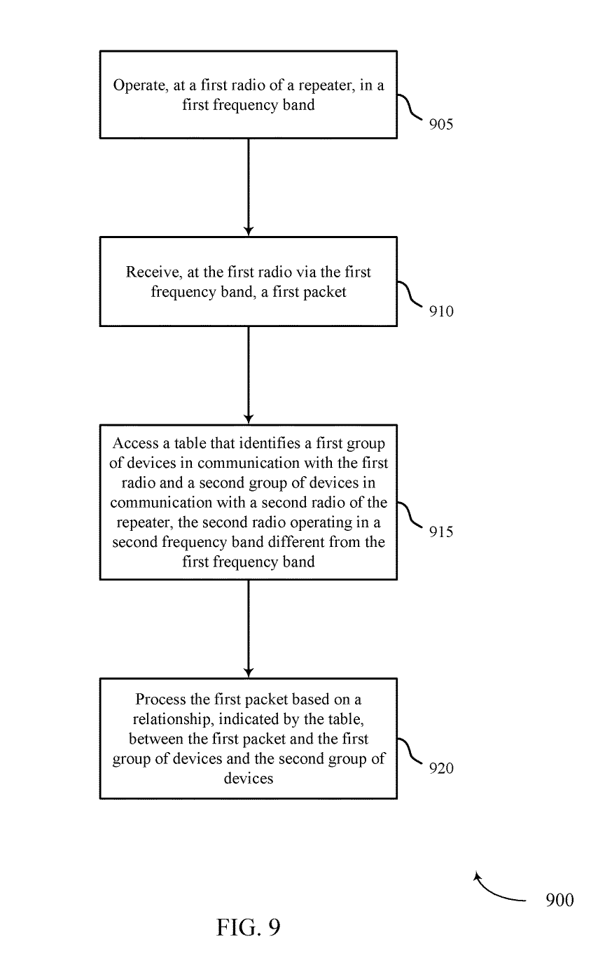

FIG. 9 shows a flowchart illustrating a method 900 for DBDC resolution and load balancing in accordance with various aspects of the present disclosure. The operations of method 900 may be implemented by a DBDC repeater AP 205 or its components as described with reference to FIGS. 1-8. For example, the operations of method 900 may be performed by the DBDC repeater communications manager 510 as described with reference to FIGS. 5-8. In some examples, a DBDC repeater AP 205 may execute a set of codes to control the functional elements of the DBDC repeater AP 205 to perform the functions described below. Additionally or alternatively, the DBDC repeater AP 205 may perform aspects the functions described below using special-purpose hardware.

At block 905, the DBDC repeater AP 205 may perform operations at a first radio using a first frequency band as described with reference to FIGS. 2-4G. In certain examples, the operations of block 905 may be performed or facilitated by the DBDC repeater radio manager 605 as described with reference to FIG. 6. At block 910, the DBDC repeater AP 205 may receive, at the first radio via the first frequency band, a first packet as described with reference to FIGS. 2-4G. In certain examples, the operations of block 910 may be performed or facilitated by the DBDC data receiver 610 as described with reference to FIG. 6.

Proceeding to block 915, the DBDC repeater AP 205 may access a table (e.g., a connection table) that identifies a first group of devices in communication with the first radio and a second group of devices in communication with a second radio of the repeater, the second radio operating in a second frequency band different from the first frequency band as described with reference to FIGS. 2-4G. In some cases, the first frequency is 2.4 GHz and the second frequency is 5 GHz. In certain examples, the operations of block 915 may be performed or facilitated by the connection table manager 615 as described with reference to FIG. 6. At block 920, the DBDC repeater AP 205 may process the first packet based at least in part on a relationship, indicated by the table, between the first packet and at least one of the first group of devices and the second group of devices as described with reference to FIGS. 2-4G. In certain examples, the operations of block 920 may be performed or facilitated by the data processing coordinator 620 as described with reference to FIG. 6.

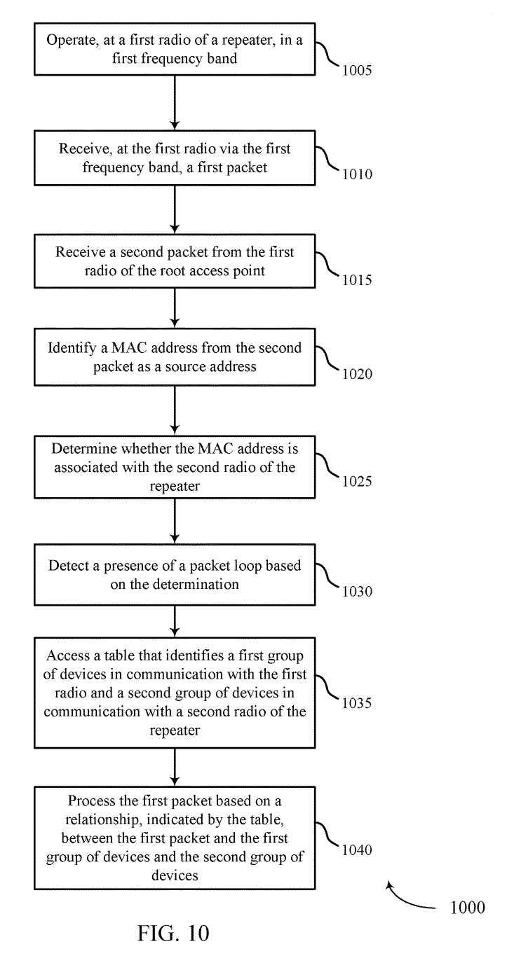

FIG. 10 shows a flowchart illustrating a method 1000 for DBDC loop resolution and load balancing in accordance with various aspects of the present disclosure. The operations of method 1000 may be implemented by a DBDC repeater AP 205 or its components as described with reference to FIGS. 1-8. For example, the operations of method 1000 may be performed by the DBDC repeater communications manager 510 as described with reference to FIGS. 5-8. In some examples, a DBDC repeater AP 205 may execute a set of codes to control the functional elements of the DBDC repeater AP 205 to perform the functions described below. Additionally or alternatively, the DBDC repeater AP 205 may perform aspects the functions described below using special-purpose hardware. The method 1000 may also incorporate aspects of method 900 of FIG. 9.

At block 1005, the DBDC repeater AP 205 may perform operations at a first radio using a first frequency band as described with reference to FIGS. 2-4G. In certain examples, the operations of block 1005 may be performed or facilitated by the DBDC repeater radio manager 605 as described with reference to FIG. 6. At block 1010, the DBDC repeater AP 205 may receive, at the first radio via the first frequency band, a first packet as described with reference to FIGS. 2-4G. In certain examples, the operations of block 1010 may be performed or facilitated by the DBDC data receiver 610 as described with reference to FIG. 6.

At block 1015, the DBDC repeater AP 205 may receive a second packet from the first radio of the root access point as described with reference to FIGS. 2-4G. In certain examples, the operations of block 1015 may be performed or facilitated by the DBDC data receiver 610 as described with reference to FIG. 6. At block 1020, the DBDC repeater AP 205 may identify a MAC address from the second packet as a source address as described with reference to FIGS. 2-4G. In certain examples, the operations of block 1020 may be performed or facilitated by the address identifier 710 as described with reference to FIG. 7. Proceeding to block 1025, the DBDC repeater AP 205 may determine whether the MAC address is associated with the second radio as described with reference to FIGS. 2-4G. In certain examples, the operations of block 1025 may be performed or facilitated by the connection table manager 615 as described with reference to FIG. 6. At block 1030, the DBDC repeater AP 205 may detect a presence of a packet loop based at least in part on the determination as described with reference to FIGS. 2-4G. In certain examples, the operations of block 1030 may be performed or facilitated by the loop detector 715 as described with reference to FIG. 7.

At block 1035, the DBDC repeater AP 205 may access a table that identifies a first group of devices in communication with the first radio and a second group of devices in communication with a second radio of the repeater, the second radio operating in a second frequency band different from the first frequency band as described with reference to FIGS. 2-4G. In some cases, accessing the table may be based at least in part on the detection of the packet loop. In certain examples, the operations of block 1035 may be performed or facilitated by the connection table manager 615 as described with reference to FIG. 6.

At block 1040, the DBDC repeater AP 205 may process the first packet based at least in part on a relationship, indicated by the table, between the first packet and at least one of the first group of devices and the second group of devices as described with reference to FIGS. 2-4G. In some cases, the processing may also be based on the detection of the packet loop. In certain examples, the operations of block 1040 may be performed or facilitated by the data processing coordinator 620 as described with reference to FIG. 6.

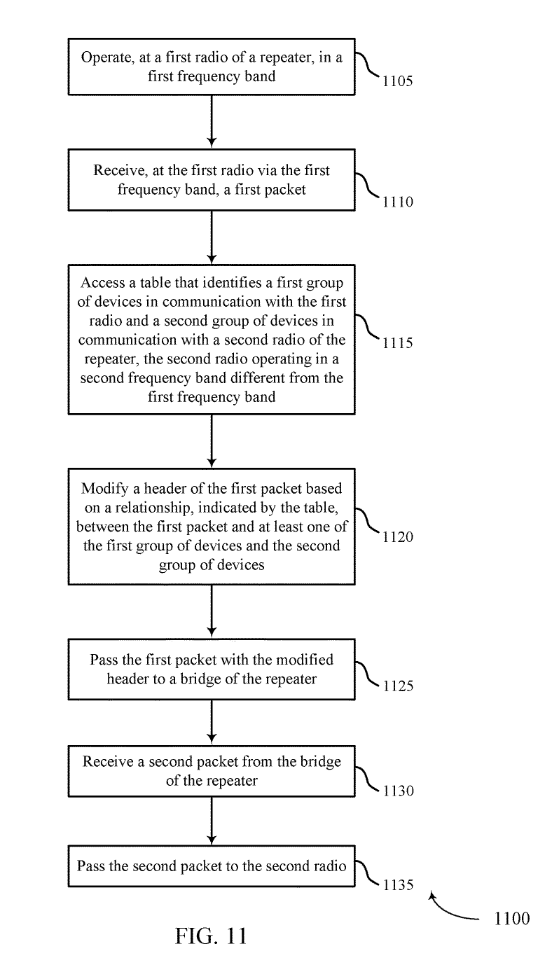

FIG. 11 shows a flowchart illustrating a method 1100 for DBDC loop resolution and load balancing in accordance with various aspects of the present disclosure. The operations of method 1100 may be implemented by an DBDC repeater AP 205 or its components as described with reference to FIGS. 1-8. For example, the operations of method 1100 may be performed by the DBDC repeater communications manager 510 as described with reference to FIGS. 5-8. In some examples, a DBDC repeater AP 205 may execute a set of codes to control the functional elements of the DBDC repeater AP 205 to perform the functions described below. Additionally or alternatively, the DBDC repeater AP 205 may perform aspects the functions described below using special-purpose hardware. The method 1100 may also incorporate aspects of methods 900, and 1000 of FIGS. 9 and 10.

At block 1105, the DBDC repeater AP 205 may perform operations at a first radio using a first frequency band as described with reference to FIGS. 2-4G. In certain examples, the operations of block 1105 may be performed or facilitated by the DBDC repeater radio manager 605 as described with reference to FIG. 6. At block 1110, the DBDC repeater AP 205 may receive, at the first radio via the first frequency band, a first packet as described with reference to FIGS. 2-4G. In certain examples, the operations of block 1110 may be performed or facilitated by the DBDC data receiver 610 as described with reference to FIG. 6. Proceeding to block 1115, the DBDC repeater AP 205 may access a table (e.g., a connection table) that identifies a first group of devices in communication with the first radio and a second group of devices in communication with a second radio of the repeater, the second radio operating in a second frequency band different from the first frequency band as described with reference to FIGS. 2-4G. In certain examples, the operations of block 1115 may be performed or facilitated by the connection table manager 615 as described with reference to FIG. 6.

At block 1120, the DBDC repeater AP 205 may modify a header of the first packet based on a relationship, indicated by the table, between the first packet and at least one of the first group of devices and the second group of devices. In one example, the first radio that receives the first packet is the non-default radio. In such a scenario, the non-default radio STA-VAP may pass the first packet to the default radio STA-VAP which modifies the header of the first packet before passing it to the bridge. In some cases, modification of the header may not be needed before it is passed to the bridge (e.g., when the first packet is received over the air at the default radio). Proceeding to black 1125, the DBDC repeater AP 205 may pass the first packet with the modified header to the bridge of the DBDC repeater AP 205. In certain examples, the operations of blocks 1120 and 1125 may be performed or facilitated by the data processing coordinator 620 as described with reference to FIG. 6.

At block 1130, the DBDC repeater AP 205 may receive a second packet from the bridge of the DBDC repeater. For example, the bridge may pass the second packet to the default STA-VAP. In such a scenario, the default STA-VAP may determine the relationship between the source address of the second packet and one of the groups of devices (e.g., by referencing a connection table). If the source address corresponds to a client in the group of devices behind the default radio, the default radio STA-VAP may transmit the second packet over the air to the root AP using the default radio. If the sources address corresponds to a client in the group of devices behind the non-default radio, the default radio STA-VAP may internally pass the second packet to the non-default radio STA-VAP for transmission over the air to the root AP using the non-default radio. In the present example, the packet source is a client station associated with the group of devices behind the non-default radio. Accordingly, at block 1135, the DBDC repeater AP 205 may pass the second packet to the second (e.g., non-default) radio. In certain examples, the operations of blocks 1130 and 1135 may be performed or facilitated by the DBDC data receiver 610 as described with reference to FIG. 6

Thus, methods 900, 1000, and 1100 may provide for dual band dual concurrent loop resolution and load balancing. It should be noted that methods 900, 1000, and 1100 describe possible implementation, and that the operations and the steps may be rearranged or otherwise modified such that other implementations are possible. In some examples, aspects from two or more of the methods 900, 1000, and 1100 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method of wireless communication, comprising:
operating, at a first radio of a repeater, in a first frequency band;
receiving, at the first radio via the first frequency band, a first packet;
accessing a table that identifies a first group of devices in communication with the first radio and a second group of devices in communication with a second radio of the repeater, the second radio operating in a second frequency band different from the first frequency band; and
processing the first packet based at least in part on a relationship, indicated by the table, between the first packet and at least one of the first group of devices and the second group of devices.

2. The method of claim 1, further comprising:
identifying a first connection between the first radio of the repeater and a first radio of a root access point, the first radio of the root access point operating in the first frequency band; and
identifying a second connection between the second radio of the repeater and a second radio of the root access point, the second radio of the root access point operating in the second frequency band.

3. The method of claim 2, further comprising:
receiving a second packet from the first radio of the root access point; and
identifying a medium access control (MAC) address from the second packet as a source address.

4. The method of claim 3, further comprising:
determining whether the MAC address is associated with the second radio of the repeater; and
detecting a presence of a packet loop based at least in part on the determination.

5. The method of claim 3, wherein the second packet comprises a layer two update frame.

6. The method of claim 3, wherein the second packet comprises a multicast packet.

7. The method of claim 1, wherein processing the first packet comprises:
modifying a header of the first packet; and
the method further comprising passing the first packet with the modified header to a bridge of the repeater.

8. The method of claim 7, further comprising:
receiving a second packet from the bridge of the repeater; and
passing the second packet to the second radio of the repeater.

9. The method of claim 1, wherein the first packet comprises Ethernet traffic.

10. The method of claim 1, wherein processing the first packet comprises:
dynamically transmitting the first packet using either the first radio of the repeater or the second radio of the repeater.

11. The method of claim 1, wherein processing the first packet comprises:
discarding the first packet.

12. The method of claim 1, wherein processing the first packet comprises:
transmitting the first packet to a first radio of a root access point that is operating in the first frequency band.

13. The method of claim 1, wherein processing the first packet comprises:
passing the first packet to a bridge of the repeater.

14. The method of claim 1, wherein the first radio of the repeater operates in a 2.4 GHz band and the second radio of the repeater operates in a 5 GHz band.

15. An apparatus for wireless communication, comprising:
a dual band dual concurrent (DBDC) repeater radio manager to facilitate operations at a first radio of a repeater, the first radio operating in a first frequency band;
a DBDC data receiver to receive, at the first radio via the first frequency band, a first packet;
a connection table manager to access a table that identifies a first group of devices in communication with the first radio and a second group of devices in communication with a second radio of the repeater, the second radio operating in a second frequency band different from the first frequency band; and
a data processing coordinator to process the first packet based at least in part on a relationship, indicated by the table, between the first packet and at least one of the first group of devices and the second group of devices.

16. The apparatus of claim 15, further comprising:
a connection monitor to identify a first connection between the first radio of the repeater and a first radio of a root access point, the first radio of the root access point operating in the first frequency band; and wherein
the connection monitor identifies a second connection between the second radio of the repeater and a second radio of the root access point, the second radio of the root access point operating in the second frequency band.

17. The apparatus of claim 16, wherein the DBDC data receiver receives a second packet from the first radio of the root access point, and wherein the apparatus further comprises:
an address identifier to identify a medium access control (MAC) address from the second packet as a source address.

18. The apparatus of claim 17, wherein the connection table manager determines whether the MAC address is associated with the second radio of the repeater, and wherein the apparatus further comprises:
a loop detector to detect a presence of a packet loop based at least in part on the determination.

19. The apparatus of claim 17, wherein the second packet is from the group consisting of: a layer two update frame and a multicast packet.

20. The apparatus of claim 15, wherein processing the first packet comprises modifying a header of the first packet, and wherein the apparatus further comprises:
a data processing coordinator to pass the first packet with the modified header to a bridge of the repeater.

21. The apparatus of claim 20, wherein the a dual band dual concurrent (DBDC) data receiver receives a second packet from the bridge of the repeater, and wherein the data processing coordinator passes the second packet to the second radio of the repeater.

22. The apparatus of claim 15, wherein the first radio of the repeater operates in a 24 GHz band and the second radio of the repeater operates in a 5 GHz band.

23. An apparatus for wireless communication, comprising:
a processor;
memory in electronic communication with the processor; and
instructions stored in the memory and operable, when executed by the processor, to cause the apparatus to:
operate, at a first radio of the apparatus, in a first frequency band;
receive, at the first radio via the first frequency band, a first packet;
access a table that identifies a first group of devices in communication with the first radio and a second group of devices in communication with a second radio of the apparatus, the second radio operating in a second frequency band different from the first frequency band; and
process the first packet based at least in part on a relationship, indicated by the table, between the first packet and at least one of the first group of devices and the second group of devices.

24. The apparatus of claim 23, wherein the instructions are operable to cause the apparatus to:
identify a first connection between the first radio of the apparatus and a first radio of a root access point, the first radio of the root access point operating in the first frequency band; and
identify a second connection between the second radio of the apparatus and a second radio of the root access point, the second radio of the root access point operating in the second frequency band.

25. The apparatus of claim 24, wherein the instructions are operable to cause the apparatus to:
receive a second packet from the first radio of the root access point; and
identify a medium access control (MAC) address from the second packet as a source address.

26. The apparatus of claim 25, wherein the instructions are operable to cause the apparatus to:
determine whether the MAC address is associated with the second radio of the apparatus; and
detect a presence of a packet loop based at least in part on the determination.

27. The apparatus of claim 23, wherein processing the first packet comprises:
modifying a header of the first packet; and
wherein the instructions are operable to cause the apparatus to pass the first packet with the modified header to a bridge of the apparatus.

28. The apparatus of claim 27, wherein the instructions are operable to cause the apparatus to:
receive a second packet from the bridge of the apparatus; and
pass the second packet to the second radio of the apparatus.

29. A non-transitory computer-readable medium storing code for wireless communication, the code comprising instructions executable to:
operate, at a first radio of a repeater, in a first frequency band;
receive, at the first radio via the first frequency band, a first packet;
access a table that identifies a first group of devices in communication with the first radio and a second group of devices in communication with a second radio of the repeater, the second radio operating in a second frequency band different from the first frequency band; and
process the first packet based at least in part on a relationship, indicated by the table, between the first packet and at least one of the first group of devices and the second group of devices.

30. The non-transitory computer-readable medium of claim 29, wherein the instructions are executable to:
identify a first connection between the first radio of the repeater and a first radio of a root access point, the first radio of the root access point operating in the first frequency band; and
identify a second connection between the second radio of the repeater and a second radio of the root access point, the second radio of the root access point operating in the second frequency band.
